(19) United States
(12) Patent Application Publication
(10) Pub. No.: US 2010/0201606 A1
(43) Pub. Date: Aug. 12, 2010

(54) Frame expanding glasses and frame expanding visual system

(76) Inventors: Yau-Wing Chung, Shindian City (TW); Chi-Yin Lu, Shindian City (TW)

Correspondence Address: MH2 TECHNOLOGY LAW GROUP, LLP, 1951 KIDWELL DRIVE, SUITE 550, TYSONS CORNER, VA, 22182, US

(21) Appl. No.: 12/654,813

(22) Filed: Jan. 5, 2010

(30) Foreign Application Priority Data
Feb. 6, 2009 (TW) 098103873

(51) Int. Cl. G09G 5/00

(52) U.S. Cl. 345/8

(57) ABSTRACT

Frame expanding glasses adapted to be used with a display apparatus for making a user observe an expanding frame are provided. The frame expanding glasses include a left eye optical module and a right eye optical module. The left eye optical module is disposed between a left eye frame and the left eye of the user. The left eye optical module includes a left eye prism and a first frame selector. The right eye optical module is disposed between a right eye frame and the right eye of the user. The right eye optical module includes a right eye prism and a second frame selector. A frame expanding visual system using the frame expanding glasses is also provided.

### BACKGROUND OF THE INVENTION

1. Field of the Invention

The invention relates to optical glasses and a visual system, and more particularly to frame expanding glasses and a frame expanding visual system.

2. Description of Related Art

As the display technology developed, the quality of the display frame is advanced with high resolution, high color saturation, high contrast, and high brightness. Additionally, aspect ratio of the display frame of the common display device has great change. According to the research, the two eyes are at the same horizontal line when a person stands or sits, a wide display frame is suitable for humans, and the wide display frame may have better visual effect. The traditional display device with an aspect ratio of 4:3 is out of time, and currently, the flat-panel TVs(televisions), for example, Liquid crystal TVs and plasma TVs may have an aspect ratio of 16:9.

However, in the field of projection display device, the bigger the aspect ratio of the display frame, the higher the price of the projection display device. For example, the price of a projection device capable of projecting a movie frame (aspect ratio is 2.35:1) is higher than the price of a projection device with an aspect ratio of 16:9, and the price of the projection device with the aspect ratio of 16:9 is higher than the price of traditional device with an aspect ratio of 4:3. Moreover, the price of the projection device capable of projecting high resolution display frame is high, and the high price make the high-level projection device hardly popularize in a family.

The main reason of the high price of the projection device capable of projecting the display frame with a bigger aspect ratio and a higher resolution depends on the light valve, the kernel of the projection device. The cost of the light valve, for example LCOS panel (liquid crystal on silicon panel), DMD (digital micro-mirror device), may increase with the increasing of the resolution. Reducing the cost of the projection device is the key issue of popularization of projection device in common family.

### SUMMARY OF THE INVENTION

The invention provides frame expanding glasses capable of providing a frame having a bigger size and a higher resolution for a user with lower cost.

The invention provides a frame expanding visual system capable of providing a frame having a bigger size and a higher resolution for a user with lower cost.

One embodiment of the invention provides frame expanding glasses, adapted to be used with a display apparatus for making a user observe a plurality of expanding frames. The display apparatus is capable of displaying a plurality of sets of left eye frames and right eye frames, and the left eye frame and the right eye frame in the same set compose the expanding frame. The frame expanding glasses include a left eye optical module and a right eye optical module. The left eye optical module is disposed between the left eye frame and the left eye of the user, and the left eye optical module includes a left eye prism and a first frame selector. The left eye prism is disposed in a light path of a left-eye-frame beam transmitted from the left eye frame, and the left eye prism has a first light incident surface facing the left eye frame and a first light emitting surface facing the left eye of the user. The first frame selector is disposed in a light path of a right-eye-frame beam transmitted from the right eye frame and in the light path of the left-eye-frame beam, wherein the first frame selector is capable of making the left-eye-frame beam pass through and transmit to the left eye of the user and blocking the right-eye-frame beam. The right eye optical module is disposed between the right eye frame and the right eye of the user, and the right eye optical module includes a right eye prism and a second frame selector. The right eye prism is disposed in the light path of the right-eye-frame beam, and the right eye prism has a second light incident surface facing the right eye frame and a second light emitting surface facing the right eye of the user. A distance between the first light incident surface and the first light emitting surface along a direction parallel to an axis of the left eye of the user is gradually increased along a direction toward the right eye prism, and a distance between the second light incident surface and the second light emitting surface along a direction parallel to an axis of the right eye of the user is gradually increased along a direction toward the left eye prism. The second frame selector is disposed in the light path of the left-eye-frame beam and in the light path of the right-eye-frame beam and the second frame selector is capable of making the right-eye-frame beam pass through and transmit to the right eye of the user and blocking the left-eye-frame beam.

In one embodiment of the invention, the frame expanding glasses further include a synchronous signal receiver electrically connected to the first frame selector and the second frame selector. The display apparatus is electrically connected to a synchronous signal emitter, and the display apparatus is capable of displaying the left eye frames and the right eye frames alternately. The first frame selector and the second frame selector are, for example, liquid crystal shutter glasses. The synchronous signal emitter sends a first synchronous signal to the synchronous signal receiver to open the first frame selector for making the left-eye-frame beam pass through and to close the second frame selector for blocking the left-eye-frame beam when the display apparatus displays the left eye frame, and the synchronous signal emitter sends a second synchronous signal to the synchronous signal receiver to open the second frame selector for making the right-eye-frame beam pass through and to close the first frame selector for blocking the right-eye-frame beam when the display apparatus displays the right eye frame.

In one embodiment of the invention, the display apparatus includes a projection device. The projection device is capable of projecting a first polarized beam with a first polarizing direction to form the left eye frame on a screen, and the projection device is capable of projecting a second polarized beam with a second polarizing direction to form the right eye frame on the screen. The first frame selector includes a first polarizer capable of making the left-eye-frame beam with the first polarizing direction pass through and blocking the right-eye-frame beam with the second polarizing direction, and the second frame selector includes a second polarizer capable of making the right-eye-frame beam with the second polarizing direction pass through and blocking the left-eye-frame beam with the first polarizing direction. In the embodiment of the invention, the first polarizing direction is perpendicular to the second polarizing direction.

One embodiment of the invention provides a frame expanding visual system, the frame expanding visual system includes a display apparatus and the frame expanding glasses. The display apparatus is capable of displaying a plurality of sets of left eye frames and right eye frames for making the user observe a plurality of expanding frames, wherein the left eye frame and the right eye frame in the same set compose the expanding frame.

In one embodiment of the invention, the frame expanding visual system further includes the synchronous signal emitter electrically connected to the display apparatus. The display apparatus includes a projection device capable of projecting the sets of the left eye frames and the right eye frames on a screen.

In one embodiment of the invention, the image shape of a first partial area of the left eye frame is substantially identical with the image shape of a second partial area of the right eye frame in the same set, the left eye frame and the right eye frame compose the expanding frame when the first partial area coincides with the second partial area. The first partial area is at the right side of the left eye frame and the second partial area is at the left side of the right eye frame. The image brightness of the first partial area is fading out along a direction from left to right and the image brightness of the second partial area is fading out along the direction from right to left.

In one embodiment of the invention, the frame expanding visual system further includes a signal processing unit capable of transforming a plurality of original frames of an original frame signal into the sets of the left eye frames and the right eye frames. The signal processing unit includes a double-frequency signal processor, and the frame refresh frequency of the original frames of the original frame signal is one half of the frame refresh frequency of the sets of the left eye frames and the right eye frames.

One embodiment of the invention provides frame expanding glasses, the distance between the first light incident surface and the first light emitting surface along the direction parallel to the axis of the left eye is gradually increased along a reference direction, and the distance between the second light incident surface and the second light emitting surface along the direction parallel to the axis of the right eye is gradually decreased along the reference direction, and the referent direction is parallel to a reference plane separating the left eye prism and the right eye prism.

According to the embodiment of frame expanding glasses, since the left eye optical module and the right eye optical module are capable of making the left-eye-frame beam and the right-eye-frame beam pass through and transmit to the left eye and the right eye of the user respectively, the left eye frame and the right eye frame may compose the expanding frame, and the expanding frame is bigger than each of the left eye frame and the right eye frame. As a result, the frame expanding visual system using the frame expanding glasses may provide a bigger expanded frame with low cost for the user.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1A is a schematic view illustrating a frame expanding visual system according to one embodiment of the invention.

FIG. 1B shows the virtual image locations of a left eye frame and a right eye frame according to the frame expanding visual system of FIG. 1A.

FIG. 2 shows the left eye frame, the right eye frame, and an expanding frame generated by the frame expanding visual system of FIG. 1A.

FIG. 3 is a schematic view illustrating a frame expanding visual system according to one embodiment of the invention.

FIG. 4A is a schematic view illustrating frame expanding glasses of a frame expanding visual system according to one embodiment of the invention.

FIG. 4B is a side view of the frame expanding glasses of FIG. 4A along a D4 direction.

### DETAILED DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “disposed” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

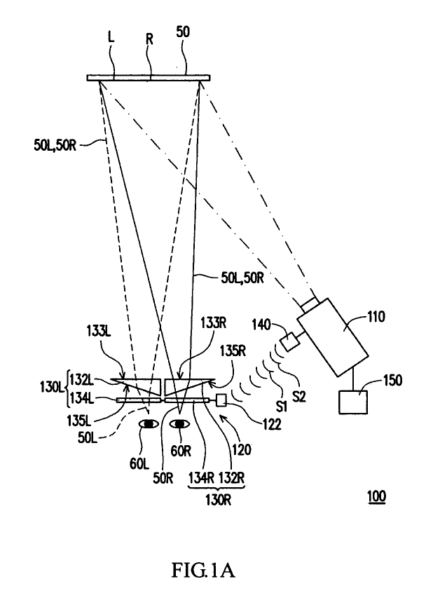

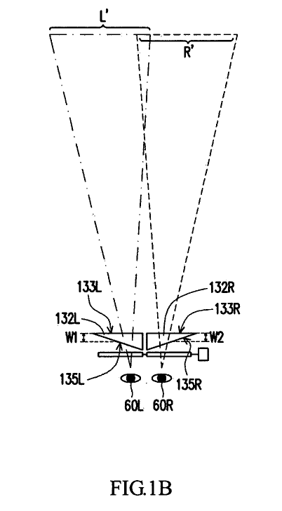

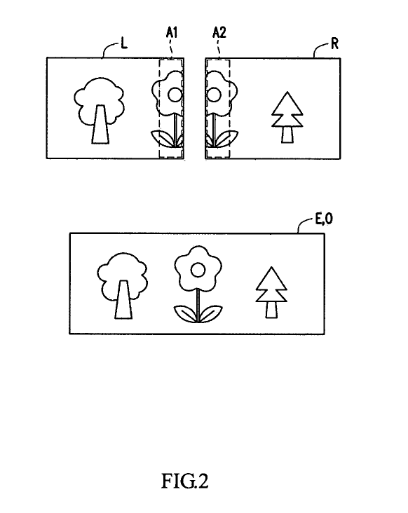

Referring to FIG. 1A, FIG. 1B, and FIG. 2, a frame expanding visual system 100 of one embodiment of the invention includes a display apparatus 110 and frame expanding glasses 120. The display apparatus 110 is capable of displaying a plurality of sets of left eye frames L and right eye frames R for making a user observe a plurality of expanding frames E (as shown in FIG. 2). In the embodiment, the display apparatus 110 is, for example, a projection device capable of projecting a plurality of sets of left eye frames L and right eye frames R on a screen 50. In other embodiments, the display apparatus 110 may be a cathode ray tube (CRT), a flat display or other suitable displays. The frame expanding visual system 100 further includes a signal processing unit 150, the signal processing unit 150 is capable of transforming a plurality of original frames O of an original frame signal into the plurality of sets of the left eye frames L and the right eye frames R, and the content of the original frame O is substantially the same with the content of the expanding frame E the user observed.

In one embodiment, the signal processing unit 150 is, for example, a double-frequency signal processor capable of making the display apparatus 110 display the left eye frames L and the right eye frames R alternately. The frame refresh frequency of the original frames O of the original frame signal is one half of the frame refresh frequency of the plurality of sets of the left eye frames L and the right eye frames R. Specifically, assuming the frame refresh frequency of the original frame O is 60 Hz, then the left eye frames L and the right eye frames R are displaying alternately at 120 Hz.

The image shape of a first partial area A1 of the left eye frame L is substantially identical with the image shape of a second partial area A2 of the right eye frame R in the same set of the left eye frames L and the right eye frames R. In the embodiment, the first partial area A1 is at right side of the left eye frame L, and the second partial area A2 is at left side of the right eye frame R. When the first partial area A1 coincides with the second partial area A2, the left eye frame L and the right eye frame R compose the expanding frame E. In other embodiments, the left eye frame and the right eye frame are different images, i.e., the left eye frame and the right eye frame have no substantially identical image shapes to coincide with each other, and the two different images of the left eye frame and the right eye frame compose an expanding frame. Specifically, the two different images of the left eye frame and the right eye frame in the same set compose one expanding frame, and a plurality of sets of different left eye frames and right eye frames compose a plurality of expanding frames.

The frame expanding glasses 120 include a left eye optical module 130L and a right eye optical module 130R. The left eye optical module 130L is disposed between the left eye frame L and the left eye 60L of the user. The left eye optical module 130L includes a left eye prism 132L and a first frame selector 134L. The left eye prism 132L is disposed in a light path of a left-eye-frame beam 50L transmitted from the left eye frame L and has a first light incident surface 133L facing the left eye frame L and a first light emitting surface 135L facing the left eye 60L of the user. In the embodiment, the left eye prism 132L is also disposed in a light path of a right-eye-frame beam 50R transmitted from the right eye frame R. In other words, the left-eye-frame beam 50L and the right-eye-frame beam 50R may pass through the first light incident surface 133L and the first light emitted surface 135L orderly.

The first frame selector 134L is disposed in the light path of the left-eye-frame beam 50L and in the light path of the right-eye-frame beam 50R, and the first frame selector 134L is capable of making the left-eye-frame beam 50L pass through and transmit to the left eye 60L of the user and blocking the right-eye-frame beam 50R.

The right eye optical module 130R is disposed between the right eye frame 50R and the right eye 60R of the user. The right eye optical module 130R includes a right eye prism 132R and a second frame selector 134R. The right eye prism 132R is disposed in a light path of the right-eye-frame beam 50R and has a second light incident surface 133R facing the right eye frame R and a second light emitting surface 135R facing the right eye 60R of the user. In the embodiment, the left-eye-frame beam 50L transmits to the right eye prism 132R and passes through the second light incident surface 133R and the second light emitted surface 135R orderly.

A distance W1 (as shown in FIG. 1B) between the first light incident surface 133L and the first light emitting surface 135L along a direction parallel to an axis of the left eye 60L of the user is gradually increased along a direction toward the right eye prism 132R, and a distance W2 between the second light incident surface 133R and the second light emitting surface 135R along a direction parallel to an axis of the right eye 60R of the user is gradually increased along a direction toward the left eye prism 132L.

The second frame selector 134R is disposed in the light path of the left-eye-frame beam 50L and in the light path of the right-eye-frame beam 50R, and the second frame selector 134R is capable of making the right-eye-frame beam 50R pass through and transmit to the right eye 60R of the user and blocking the left-eye-frame beam 50L.

In the embodiment, the left eye prism 132L is disposed between the first frame selector 134L and the left eye frame L, and the second eye prism 132R is disposed between the second frame selector 134R and the right eye frame R. In other embodiments, the first frame selector 134L may be disposed between the left eye prism 132L and the left eye frame L, and the second frame selector 134R may be disposed between the right eye prism 132R and the right eye frame R.

Since the distance W1 is gradually increased along the direction toward the right eye prism 132R, and the distance W2 is gradually increased along the direction toward the left eye prism 132L, the left-eye-frame beam 50L and the right-eye-frame beam 50R are refracted when the left-eye-frame beam 50L and the right-eye-frame beam 50R pass through the prisms 132L and 132R. The refraction of the left-eye-frame beam 50L and the right-eye-frame beam 50R makes the virtual image L′ of the left eye frame L move toward left, and makes the virtual image R′ of the right eye frame R move toward right, such that the frame viewed by the user is expanded. The coincided parts of the virtual images L′ and R′ are corresponding to the first partial area A1 and the second partial area A2, so that the left eye frame L and the right eye frame R compose the expanding frame E in the brain of the user.

In the embodiment of the invention, the image brightness of the first partial area A1 is fading out along a direction from left to right, and the image brightness of the second partial area A2 is fading out along the direction from right to left, so that the boundary of the coincided area of the first partial area A1 and the second partial area A2 is prevented from being identified.

In the embodiment, the frame expanding visual system 100 further includes a synchronous signal emitter 140 electrically connected to the display apparatus 110. The frame expanding glasses 120 further include a synchronous signal receiver 122 electrically connected to the first frame selector 134L and the second frame selector 134R. In the embodiment, the synchronous signal emitter 140 and the synchronous signal receiver 122 are, for example, infrared signal emitter and infrared signal receiver respectively. In other embodiments, the synchronous signal emitter 140 and the synchronous signal receiver 122 are signal emitter and signal receiver of other wave bands.

In the embodiment, the display apparatus 110 is capable of displaying the left eye frame L and the right eye frame R alternately, and the first frame selector 134L and the second frame selector 134R are liquid crystal shutter glasses. The synchronous signal emitter 140 sends a first synchronous signal S1 to the synchronous signal receiver 122 to open the first frame selector 134L for making the left-eye-frame beam 50L pass through and to close the second frame selector 134R for blocking the left-eye-frame beam 50L When the display apparatus 110 displays the left eye frame L, and the synchronous signal emitter 140 sends a second synchronous signal S2 to the synchronous signal receiver 122 to open the second selector 134R for making the right-eye-frame beam 50R pass through and to close the first frame selector 134L for blocking the right-eye-frame beam 50R when the display apparatus 110 displays the right eye frame R. So that, the left eye 60L of the user may only see the left eye frame L correctly, and the right eye 60R may only see the right eye frame R correctly.

The frame expanding visual system 100 of the embodiment provides the expanding frame E with high resolution and wide width without enhancing the projecting frame of the display apparatus, so that the frame expanding visual system 100 of the embodiment may provide high resolution frame with low cost. In the embodiment, each of the aspect ratios of the left eye frame L and the right eye frame R is 4:3, and the aspect ratio of the expanding frame E is 16:9 or 2.35:1. The illumination flux of the expanding frame E projected by the frame expanding visual system 100 of the embodiment is more than 1.7 times to the illumination flux of common frame with an aspect ratio of 4:3. So that the frame expanding visual system 100 of the embodiment provides the expanding frame E with high illumination flux.

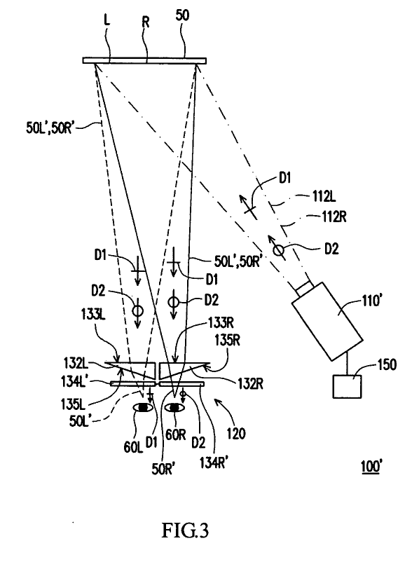

Referring to FIG. 3, the frame expanding visual system 100′ of the embodiment is similar to the frame expanding visual system 100 (as shown in FIG. 1A) mentioned above, and the differences between the frame expanding visual systems 100 and 100′ are described as followed. In the visual system 100′ of the embodiment, the display apparatus 110′ is capable of projecting a first polarized beam 112L with a first polarizing direction D1 on a screen to form the left eye frame L, and the display apparatus 110′ is capable of projecting a second polarized beam 112R with a second polarizing direction D2 on the screen to form the right eye frame R. In the embodiment, the display apparatus 110′ is capable of projecting the first polarized beam 112L and the second polarized beam 112R alternately. In other embodiments, there may be two display apparatuses to project the first polarized beam 112L and the second polarized beam 112R respectively.

In the embodiment, the first frame selector 134L′ is a first polarizer capable of making the left-eye-frame beam 50L′ with the first polarizing direction D1 pass through and blocking the right-eye-frame beam 50R′ with the second polarizing direction D2. In the embodiment, the second frame selector 134R′ is a second polarizer capable of making the right-eye-frame beam 50R′ with the second polarizing direction D2 pass through and blocking the left-eye-frame beam 50L′ with the first polarizing direction D1. In the embodiment, the first direction D1 is perpendicular to the second direction D2. In other embodiments, the first direction D1 and the second direction D2 may be other suitable polarizing directions.

In the frame expanding visual system 100′ of the embodiment, the left eye 60L of the user may only see the left eye frame L, and the right eye 60R may only see the right eye frame R, so that the frame expanding visual system 100′ has similar effect with the frame expanding visual system 100 (as shown in FIG. 1A).

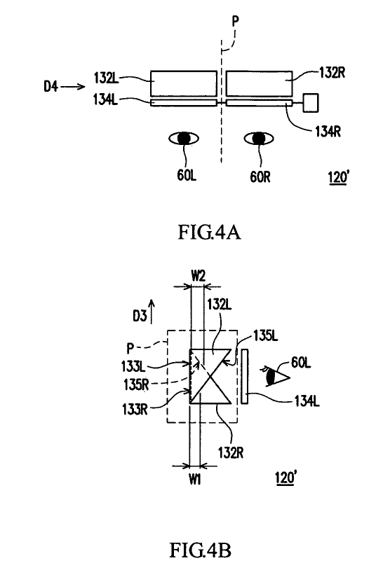

Referring to FIG. 4A and FIG. 4B, the frame expanding glasses 120′ of the embodiment are similar to the frame expanding glasses 120 (as shown in FIG. 1A), and the difference between the frame expanding glasses 120′ and the frame expanding glasses 120 is the placement directions of the left eye prism 132L and the right eye prism 132R. In the frame expanding glasses 120′, the distance W1 between the first light incident surface 133L of the left eye prism 132L and the first light emitting surface 135L of the left eye prism 132L along the direction parallel to the axis of the left eye 60L of the user is gradually increased along a reference direction D3, and the distance W2 between the second light incident surface 133R of the right eye prism 132R and the second light emitting surface 135R of the right eye prism 132R along the direction parallel to the axis of the right eye 60R is gradually decreased along the reference direction D3, and the reference direction D3 is parallel to a reference plane P separating the left eye prism 132L and the right eye prism 132R. The expanding frame viewed by the user using the frame expanding glasses 120′ of the embodiment is expanded in a vertical direction different from the horizontal expanding direction of the frame expanding glasses 120 mentioned above. In other words, the left eye frame and the right eye frame viewed by the user are arranged up and down.

In the embodiment, the left eye frame and the right eye frame may partially coincide with each other with the same image shapes of partial areas of the left eye frame and the right eye frame, and in the other side, the left eye frame and the right eye frame may be different image, i.e., the left eye frame and the right eye frame have no substantially identical image shapes to coincide with each other.

As described above, in the frame expanding glasses of the embodiment, since the left eye optical module is capable of making the left-eye-frame beam transmit to the left eye and the right eye optical module is capable of making the right-eye-frame beam transmit to the right eye, and the left eye frame and the right eye frame compose the expanding frame in the brain of the user. In the frame expanding glasses of the embodiment, the left eye prism and the right eye prism make the virtual image of the left eye frame and the virtual image of the right eye frame partial coincide in the space, so that the left eye frame and the right eye frame may compose the expanding frame, and the size of the expanding frame is bigger than the left eye frame or the right eye frame. The frame expanding visual system of the embodiment may provide bigger frame with low cost, and the frame expanding visual system of the embodiment may provide expanding frame with high illumination flux.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. Frame expanding glasses, adapted to be used with a display apparatus for making a user observe a plurality of expanding frames, wherein the display apparatus is capable of displaying a plurality of sets of left eye frames and right eye frames, and the left eye frame and the right eye frame in the same set compose the expanding frame, the frame expanding glasses comprising:
a left eye optical module, adapted to be disposed between the left eye frame and the left eye of the user, the left eye optical module comprising:
a left eye prism, disposed in a light path of a left-eye-frame beam transmitted from the left eye frame, and having a first light incident surface facing the left eye frame and a first light emitting surface facing the left eye of the user; and
a first frame selector, disposed in a light path of a right-eye-frame beam transmitted from the right eye frame and in the light path of the left-eye-frame beam, wherein the first frame selector is capable of making the left-eye-frame beam pass through and transmit to the left eye of the user and blocking the right-eye-frame beam; and
a right eye optical module, adapted to be disposed between the right eye frame and the right eye of the user, the right eye optical module comprising:
a right eye prism, disposed in the light path of the right-eye-frame beam, and having a second light incident surface facing the right eye frame and a second light emitting surface facing the right eye of the user, wherein a distance between the first light incident surface and the first light emitting surface along a direction parallel to an axis of the left eye of the user is gradually increased along a direction toward the right eye prism, and a distance between the second light incident surface and the second light emitting surface along a direction parallel to an axis of the right eye of the user is gradually increased along a direction toward the left eye prism; and
a second frame selector, disposed in the light path of the left-eye-frame beam and in the light path of the right-eye-frame beam, and capable of making the right-eye-frame beam pass through and transmit to the right eye of the user and blocking the left-eye-frame beam.

2. The frame expanding glasses of claim 1, further comprising a synchronous signal receiver electrically connected to the first frame selector and the second frame selector, wherein the display apparatus is electrically connected to a synchronous signal emitter, the display apparatus is capable of displaying the left eye frames and the right eye frames alternately, and the first frame selector and the second frame selector are liquid crystal shutter glasses, the synchronous signal emitter sends a first synchronous signal to the synchronous signal receiver to open the first frame selector for making the left-eye-frame beam pass through and to close the second frame selector for blocking the left-eye-frame beam when the display apparatus displays the left eye frame, and the synchronous signal emitter sends a second synchronous signal to the synchronous signal receiver to open the second frame selector for making the right-eye-frame beam pass through and to close the first frame selector for blocking the right-eye-frame beam when the display apparatus displays the right eye frame.

3. The frame expanding glasses of claim 1, wherein the display apparatus comprises a projection device, the projection device is capable of projecting a first polarized beam with a first polarizing direction on a screen to form the left eye frame, the projection device is capable of projecting a second polarized beam with a second polarizing direction on the screen to form the right eye frame, the first frame selector comprises a first polarizer capable of making the left-eye-frame beam with the first polarizing direction pass through and blocking the right-eye-frame beam with the second polarizing direction, and the second frame selector comprises a second polarizer capable of making the right-eye-frame beam with the second polarizing direction pass through and blocking the left-eye-frame beam with the first polarizing direction.

4. The frame expanding glasses of claim 3, wherein the first polarizing direction is perpendicular to the second polarizing direction.

5. A frame expanding visual system, comprising:
a display apparatus, capable of displaying a plurality of sets of left eye frames and right eye frames for making a user observe a plurality of expanding frames, wherein the left eye frame and the right eye frame in the same set compose the expanding frame; and
frame expanding glasses, comprising:
a left eye optical module, disposed between the left eye frame and the left eye of the user, the left eye optical module comprising:
a left eye prism, disposed in a light path of a left-eye-frame beam transmitted from the left eye frame, and having a first light incident surface facing the left eye frame and a first light emitting surface facing the left eye of the user; and
a first frame selector, disposed in a light path of a right-eye-frame beam transmitted from the right eye frame and in the light path of the left-eye-frame beam, wherein the first frame selector is capable of making the left-eye-frame beam pass through and transmit to the left eye of the user and blocking the right-eye-frame beam; and
a right eye optical module, disposed between the right eye frame and the right eye of the user, the right eye optical module comprising:
a right eye prism, disposed in the light path of the right-eye-frame beam, and having a second light incident surface facing the right eye frame and a second light emitting surface facing the right eye of the user, wherein a distance between the first light incident surface and the first light emitting surface along a direction parallel to an axis of the left eye of the user is gradually increased along a direction toward the right eye prism, and a distance between the second light incident surface and the second light emitting surface along a direction parallel to an axis of the right eye of the user is gradually increased along a direction toward the left eye prism; and
a second frame selector, disposed in the light path of the left-eye-frame beam and in the light path of the right-eye-frame beam, and capable of making the right-eye-frame beam pass through and transmit to the right eye of the user and blocking the left-eye-frame beam.

6. The frame expanding visual system of claim 5, further comprising a synchronous signal emitter electrically connected to the display apparatus, wherein the frame expanding glasses further comprise a synchronous signal receiver electrically connected to the first frame selector and the second frame selector, the display apparatus is capable of displaying the left eye frames and the right eye frames alternately, and the first frame selector and the second frame selector are liquid crystal shutter glasses, the synchronous signal emitter sends a first synchronous signal to the synchronous signal receiver to open the first frame selector for making the left-eye-frame beam pass through and to close the second frame selector for blocking the left-eye-frame beam when the display apparatus displays the left eye frame, and the synchronous signal emitter sends a second synchronous signal to the synchronous signal receiver to open the second frame selector for making the right-eye-frame beam pass through and to close the first frame selector for blocking the right-eye-frame beam when the display apparatus displays the right eye frame.

7. The frame expanding visual system of claim 5, wherein the display apparatus comprises a projection device capable of projecting the sets of the left eye frames and the right eye frames on a screen.

8. The frame expanding visual system of claim 7, wherein the projection device is capable of projecting a first polarized beam with a first polarizing direction on the screen to form the left eye frame, the projection device is capable of projecting a second polarized beam with a second polarizing direction on the screen to form the right eye frame, the first frame selector comprises a first polarizer capable of making the left-eye-frame beam with the first polarizing direction pass through and blocking the right-eye-frame beam with the second polarizing direction, and the second frame selector comprises a second polarizer capable of making the right-eye-frame beam with the second polarizing direction pass through and blocking the left-eye-frame beam with the first polarizing direction.

9. The frame expanding visual system of claim 8, wherein the first polarizing direction is perpendicular to the second polarizing direction.

10. The frame expanding visual system of claim 5, wherein the image shape of a first partial area of the left eye frame is substantially identical with the image shape of a second partial area of the right eye frame in the same set, and the left eye frame and the right eye frame compose the expanding frame when the first partial area coincides with the second partial area.

11. The frame expanding visual system of claim 10, wherein the first partial area is at the right side of the left eye frame, and the second partial area is at the left side of the right eye frame.

12. The frame expanding visual system of claim 11, wherein the image brightness of the first partial area is fading out along a direction from left to right, the image brightness of the second partial area is fading out along the direction from right to left.

13. The frame expanding visual system of claim 5, further comprising a signal processing unit capable of transforming a plurality of original frames of an original frame signal into the sets of the left eye frames and the right eye frames.

14. The frame expanding visual system of claim 13, wherein the signal processing unit comprises a double-frequency signal processor and the frame refresh frequency of the original frames of the original frame signal is one half of the frame refresh frequency of the sets of the left eye frames and the right eye frames.

15. Frame expanding glasses, adapted to be used with a display apparatus for making a user observe a plurality of expanding frames, wherein the display apparatus is capable of displaying a plurality of sets of left eye frames and right eye frames, and the left eye frame and the right eye frame of the same set compose the expanding frame, the frame expanding glasses comprising:
a left eye optical module, adapted to be disposed between the left eye frame and the left eye of the user, the left eye optical module comprising:
a left eye prism, disposed in a light path of a left-eye-frame beam transmitted from the left eye frame, and having a first light incident surface facing the left eye frame and a first light emitting surface facing the left eye of the user; and
a first frame selector, disposed in a light path of a right-eye-frame beam transmitted from the right eye frame and in the light path of the left-eye-frame beam, wherein the first frame selector is capable of making the left-eye-frame beam pass through and transmit to the left eye of the user and blocking the right-eye-frame beam; and
a right eye optical module, adapted to be disposed between the right eye frame and the right eye of the user, the right eye optical module comprising:
a right eye prism, disposed in the light path of the right-eye-frame beam, and having a second light incident surface facing the right eye frame and a second light emitting surface facing the right eye of the user, wherein a distance between the first light incident surface and the first light emitting surface along a direction parallel to an axis of the left eye is gradually increased along a reference direction, and a distance between the second light incident surface and the second light emitting surface along a direction parallel to an axis of the right eye is gradually decreased along the reference direction, and the referent direction is parallel to a reference plane separating the left eye prism and the right eye prism; and
a second frame selector, disposed in the light path of the left-eye-frame beam and in the light path of the right-eye-frame beam, and capable of making the right-eye-frame beam pass through and transmit to the right eye and blocking the left-eye-frame beam.

16. The frame expanding glasses of claim 15, further comprising a synchronous signal receiver electrically connected to the first frame selector and the second frame selector, wherein the display apparatus is electrically connected to a synchronous signal emitter, the display apparatus is capable of displaying the left eye frames and the right eye frames alternately, and the first frame selector and the second frame selector are liquid crystal shutter glasses, the synchronous signal emitter sends a first synchronous signal to the synchronous signal receiver to open the first frame selector for making the left-eye-frame beam pass through and to close the second frame selector for blocking the left-eye-frame beam when the display apparatus displays the left eye frame, and the synchronous signal emitter sends a second synchronous signal to the synchronous signal receiver to open the second frame selector for making the right-eye-frame beam pass through and to close the first frame selector for blocking the right-eye-frame beam.

17. The frame expanding glasses of claim 15, wherein the display apparatus comprises a projection device, the projection device is capable of projecting a first polarized beam with a first polarizing direction on a screen to form the left eye frame, the projection device is capable of projecting a second polarized beam with a second polarizing direction on the screen to form the right eye frame, the first frame selector comprises a first polarizer capable of making the left-eye-frame beam with the first polarizing direction pass through and blocking the right-eye-frame beam with the second polarizing direction, and the second frame selector comprises a second polarizer capable of making the right-eye-frame beam with the second polarizing direction pass through and blocking the left-eye-frame beam with the first polarizing direction.

18. The frame expanding glasses of claim 17, wherein the first polarizing direction is perpendicular to the second polarizing direction.
